(19) United States
(12) Patent Application Publication
(10) Pub. No.: US 2021/0006295 A1
(43) Pub. Date: Jan. 7, 2021

(54) ELECTRICAL CONVERTER ADAPTERS FOR INCREASED MODULARITY IN A PRODUCT TRANSFER SYSTEM

(71) Applicant: Cornerstone Automation Systems, LLC, Frisco, TX (US)

(72) Inventors: Tom Karol, Frisco, TX (US); Richard Steele, Frisco, TX (US); Brian McInnis, Frisco, TX (US); Hamed Sedeghi, Frisco, TX (US); Ikram Khan, Frisch, TX (US)

(21) Appl. No.: 16/919,920

(22) Filed: Jul. 2, 2020

Related U.S. Application Data
(60) Provisional application No. 62/870,838, filed on Jul. 5, 2019.

(51) Int. Cl. H04B 3/54; H01R 31/06

(52) U.S. Cl. CPC H04B 3/54; H01R 31/065

(57) ABSTRACT

Disclosed herein are aspects of electrical adapters configured to connect a first segment with a second segment of a product moving system, wherein the electrical connection of the first segment is incompatible with an electrical connection of the second segment. In some embodiments, the adapter may comprise at least a female connector at one end; and a male connector at an opposing end, the male connector coupled with the female connector via wiring; wherein the female connector is a six jack connector wherein at least a first of the six jacks is configured for AC power, and at least a second of the six jacks is configured for relaying control signals; and wherein the male connector is a nine plug connector having at least a one plug configured for AC power, and at least two plugs configured for relaying control signals.

### CROSS-REFERENCE TO RELATED APPLICATION

This application claims the benefit of U.S. Provisional Application Ser. No. 62/870,838, filed by Tom Karol, et al. on Jul. 5, 2019, entitled “ELECTRICAL CONVERTER ADAPTERS FOR INCREASED MODULARITY IN A PRODUCT TRANSFER SYSTEM,” commonly assigned with this application and incorporated herein by reference in its entirety.

### TECHNICAL FIELD

This application is directed to product transfer equipment and modules, and more specifically, an electrical converter adapter that enables production transfer equipment to connect with equipment having incompatible electrical connectors.

### BACKGROUND

Modern-day automated equipment comes equipped with wiring that facilitates applications such as power, controls, signals, data communication, telemetry etc. End electrical connectors are provided on individual equipment where the wiring terminates, commonly referred to as electrical terminations or end terminals. An electrical connector is an electro-mechanical device used to join electrical terminations to create an electrical circuit. Electrical connectors generally include plugs (male-ended) and jacks (female-ended). The connectors may be used to physically integrate different pieces of equipment that make up the system. The end connectors allow power, controls, signals and data to flow through the system thereby creating a virtual eco-system made of different pieces of equipment, where each performs its designated task(s). The electrical connection may be temporary, as for portable equipment, require a tool for assembly and removal, or serve as a permanent electrical joint between two wires or devices.

Different types and sizes of electrical connectors are available in market to meet different applications. However, certain Original Equipment Manufacturers (OEMs) commonly use only a certain type of connector across their different product lines. However, there may be a challenge to system integrators trying to build a system by connecting equipment from multiple OEMs. Equipment that needs to be physically coupled within a system may come in with different/incompatible electrical connectors, thus preventing them from being physically connected. What is needed is an adapter that may be used to effectively bring together electrically incompatible connectors.

### BRIEF DESCRIPTION

Reference is now made to the following descriptions taken in conjunction with the accompanying drawings and illustrations in which:

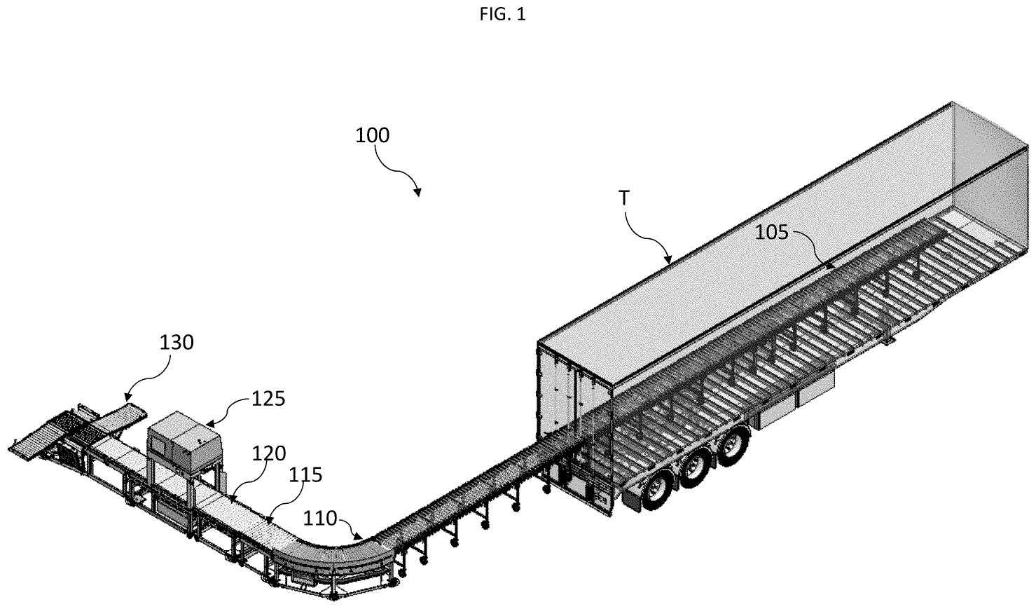

FIG. 1 is a perspective view of one embodiment of a product transfer system which may employ adapters according to the disclosure to connect equipment in the system;

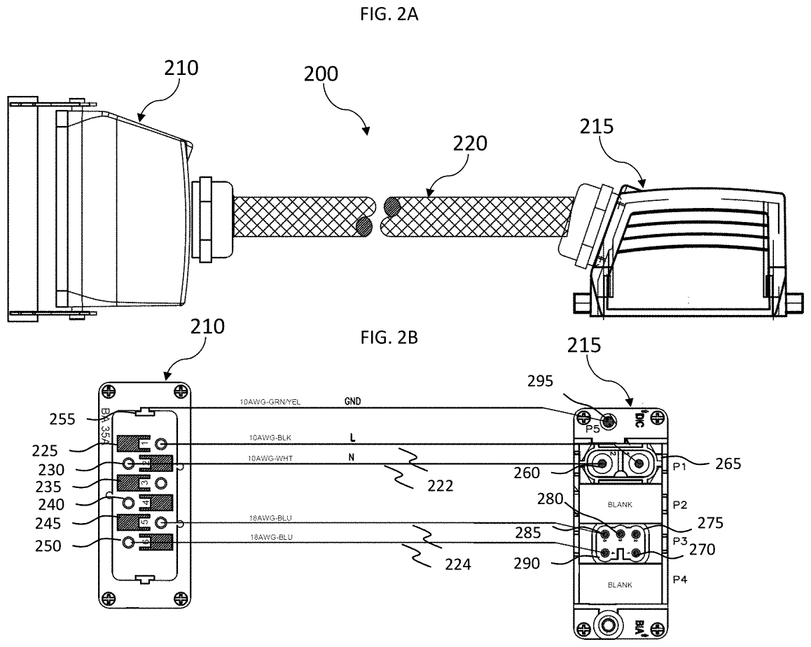

FIGS. 2A-2B illustrate one embodiment of a female to male adapter according to the disclosure;

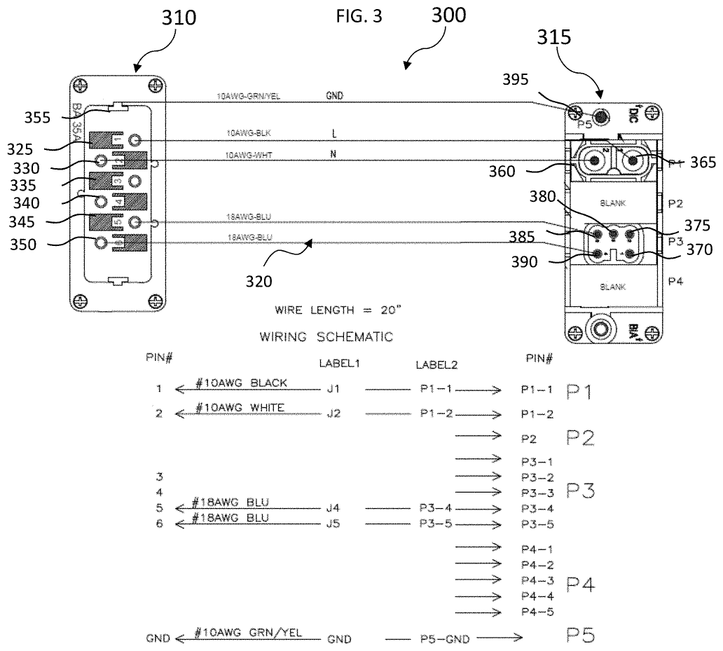

FIG. 3 illustrates another embodiment of a female to male adapter according to the disclosure;

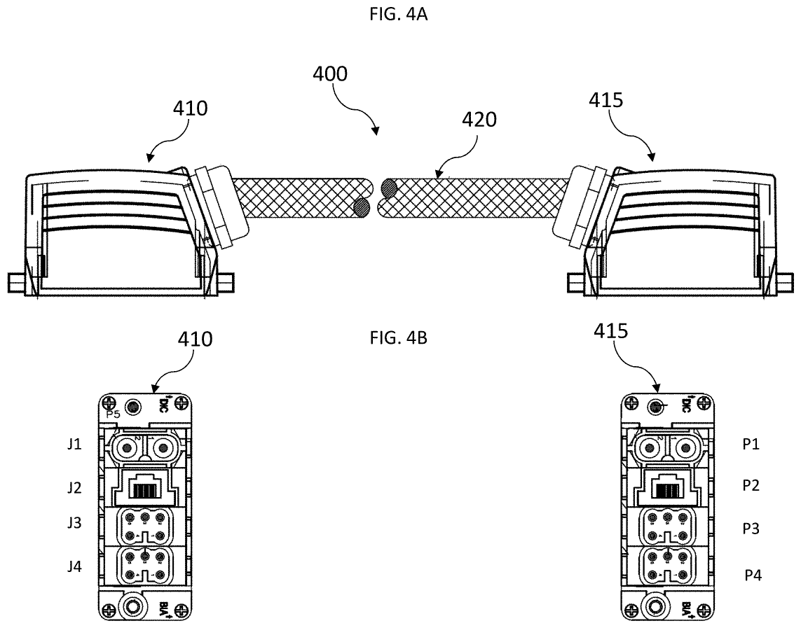

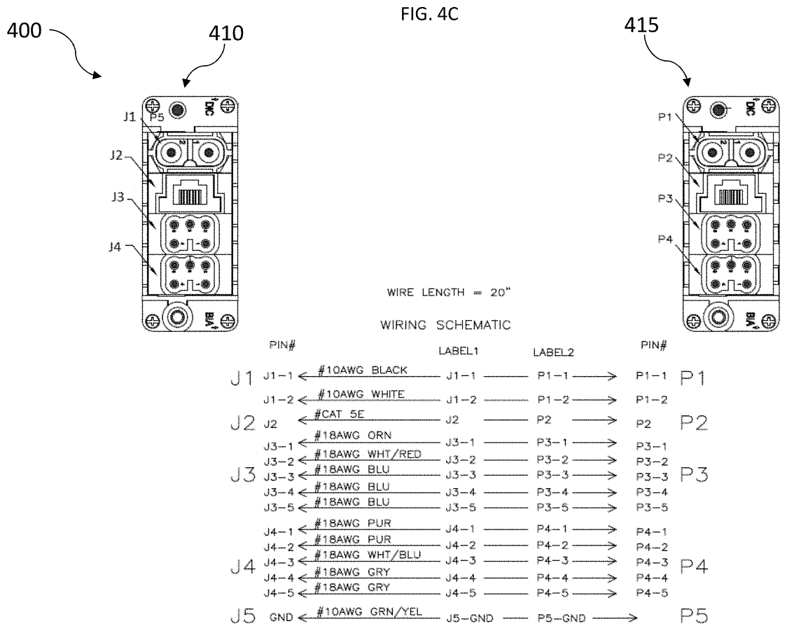

FIGS. 4A-4C illustrate one embodiment of a male to male adapter;

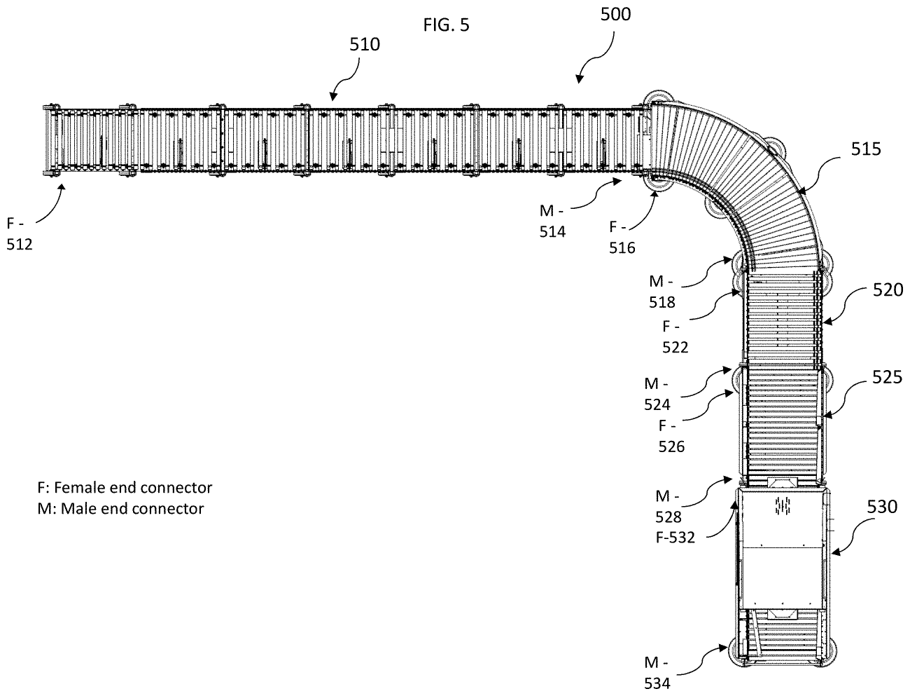

FIG. 5 illustrates one embodiment of a product transfer system having a specific configuration;

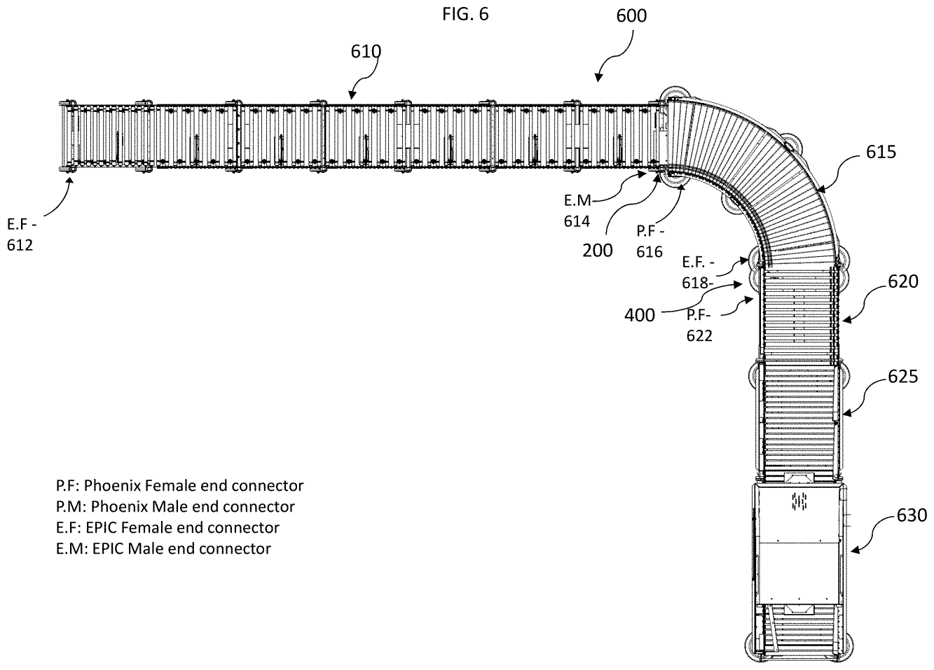

FIG. 6 illustrates another embodiment of a product transfer system having a specific configuration; and

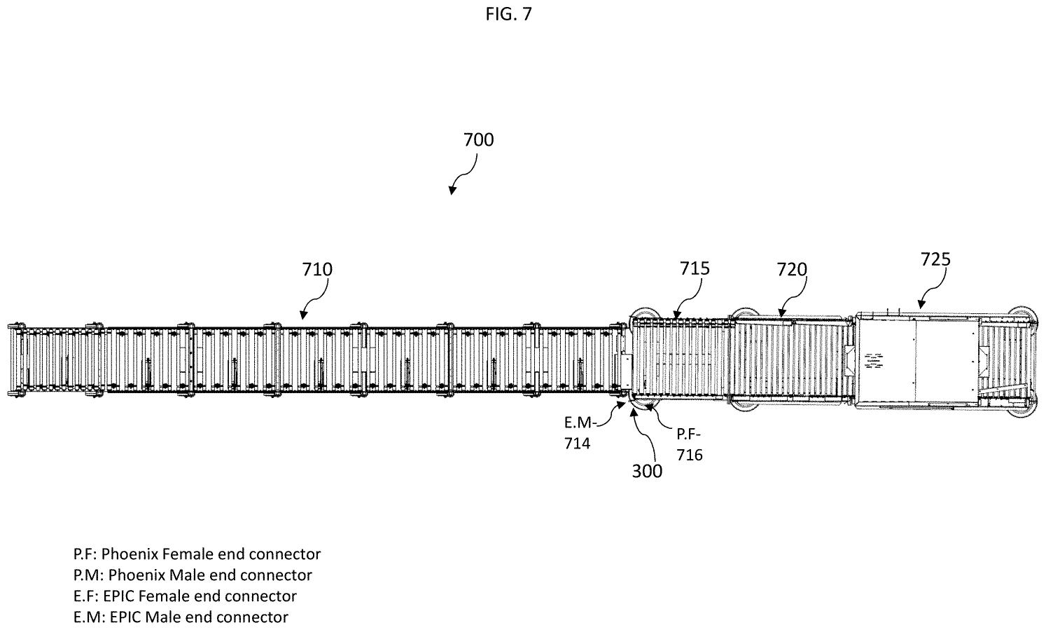

FIG. 7 illustrates yet another embodiment of a product transfer system having a specific configuration.

### DETAILED DESCRIPTION

Disclosed herein are aspects of a product transfer system and electrical adapters that may be used therein. Different OEMs for equipment, such as product transfer equipment, may prefer to use a specific type of electrical connector on their equipment. However, when an end customer tries to integrate equipment built by multiple OEMs into a product transfer system, the electrical connections of all of the equipment may not be compatible. As such, one or more electrical adapters may be needed to connect equipment that has heretofore been electrically incompatible. Being able to connect equipment with incompatible electrical connections in series may provide greater flexibility in at least the layout and installation of a product transfer system. Disclosed herein are embodiments of electrical adapters that may be used to couple together various components of a product transfer system that have been previously electrically incompatible.

In the disclosure, the terms “upstream,” downstream,” and similar terms are used in the context of a product flow stream, where product flows from “upstream” to “downstream.”

As used herein, the term “jack” may be used generally when describing to pins for a female connector and “plug” or “slot” may be used when describing pins for a male connector.

FIG. 1 illustrates one embodiment of a product transfer system 100 that may be used for unloading a trailer. A plurality of flex conveyors 105 are connected in series that allow the product to be unloaded from the trailer. A flex conveyor 105 may feed a 90° curved conveyor 110. Depending on the layout of the warehouse, curved conveyor 110 may or may not be required. The curved conveyor segment 110 may be employed to get around structural pillars or maximize use of floor space in the warehouse. The curved conveyor 110 may be connected with an extension conveyor 115. Depending on the warehouse layout and available real estate, the extension conveyor 115 may or may not be employed in the product transfer system 100. A gapping conveyor 120 may be used to receive product (boxes) and opens gaps between the product prior to feeding the product into a scanning module 125. The scanning module 125 receives the product, scans the bar code thereon, decides a sortation direction for the product, and thereafter moves the product to a sortation module 130. Various conveyors and components within the product transfer system 100 may be manufactured by various companies and manufacturers. As such, the electrical connections may not all be compatible. Accordingly, embodiments of electrical adapters according to the disclosure may enable the various components to connect with equipment from various manufacturers, when the equipment may not have been previously connectable or compatible.

Referring now to FIGS. 2A-2B, there is shown one embodiment of an electrical adapter 200 which may include female connector 210 on one end and a male connector 215 on an opposing end. The female connector 210 may be connected with the male connector 215 via a plurality of cables 220, which in some embodiments may be a cable bundles, or in some embodiments may be individual cables. In this embodiment, the female connector 210 may be a 6-pin, or 6-jack connector, such as, e.g., an EPIC female connector having a 6-pin connector. The male connector 215 may be a 9 pin or 9 plug connector, such as, e.g., a Phoenix male connector, which may be a 9-pin connector. Referring now to FIG. 2B, there is shown an end view of the female connector 210 and an end view of the male connector 215. FIG. 2B illustrates one embodiment of how the jacks of the female connector 210 may be arranged and connected with the plugs modules of the male connector 215. In this embodiment, the female connector 210 is shown as an EPIC connector having 6 pins (jacks) enclosed inside a female insert (for example, a Size 6, 6-pole, 400V, 35A). The female connector 210 includes at least 6 jacks, numbered 1 to 6. In this configuration, jack 1 225 and jack 2 230 may be wired to carry alternating current (AC) power. Jack 5 245 and jack 6 250, in this embodiment, may be wired as Interlock IN and Interlock OUT. In this embodiment, the ground connection 255 may be built into the connector 210 (labeled as GND). The male connector 215, in this example, is a 9-pin (9 plug) connector enclosed in a 4-slot module carrier frame. The male connector 215 may include at least four available slots, numbered as P1, P2, P3 and P4. Each slot may have a plurality of plugs or inserts incorporated therein. In this embodiment, slot P1 houses a 2-plug male insert P1-1 260 and P1-2 265 (for example, Male 2 positions, 40A, 1000V, Axial screw) which carries the AC power. Slot P3 may include a 5-plug male insert module (such as, e.g., a PT Spring contact insert module, male 5 positions). Within this module, The 5 plugs may include P3-1 270, P3-2 275, P3-3 280, P3-4 285 and P3-5 290. In this embodiment, P3-4 285 may be wired as Interlock OUT and P3-5 290 may be wired as Interlock IN. The male connector 215 may also, include ground plug 295, which in this embodiment may also positioned at one end of the male connector 215.

In this embodiment, the ports P2 and P4 may not include any plugs, but there may be other embodiments where P2 and P4 may be configured for various connector purposes. Similarly, jack 3 235 and jack 4 240 may not be used in this embodiment, but in some embodiments, jack 3 235 and jack 4 240 and ports P2 and P4 may be configured for various connector purposes. Further, the unused jacks, plugs, and ports of the adapter 200 may also be used to facilitate “serial communication” between adjacent equipment modules or conveyor segments. The serial communication may enable features such as “gapping” and a Zero Pressure Accumulation (ZPA) mode of functioning of an adjoining conveyor. Accordingly, the serial communication may facilitate programming intelligence or communication of operation into a dummy conveyor or similar conveyor segment that may not currently have at least the foregoing features. Other embodiments of an adapter having at least two additional jacks and ports beyond at least 6 may also include jacks or ports for enabling an Ethernet connection.

FIG. 3 is a schematic of another embodiment of an adapter 300. In this embodiment, the adapter 300 may include a female connector 310 at one end thereof and a male connector 315 at an opposing end. The female connector 310 may be connected with the male connector 315 via a plurality of cables 320. In one embodiment, the female connector 310 may be a 6-pin (6-jack) connector made by Manufacturer A. The male connector 315 may be 9-plug connector made by Manufacturer B. Jack 1 325 and Jack 2 330 within the female connector 310 may be connected to cables 322, which may be 10AWG cables which may then connect with plug P1-1 360 and plug P1-2 365 of male connector 315. This wiring configuration may enable the transfer and flow of AC power through a system having a product handling module connected with an adjacent product handling module, such as, e.g., conveyor segments and/or product sorting modules as shown in FIG. 1. Jack 5 345 and jack 6 350 of the female connector 310 may connect with plugs P3-4 and P3-5 of the male connector 215 via with cables 324, which may be e.g. 18AWG cables. These cables 324 may be configured to allow transmission of control signals through the adapter 300. Accordingly, Manufacturer B equipment may then be able to communicate with the Manufacturer equipment, because at least both AC power and control signals are communicated through the adapter 300 and adjacent equipment are enabled to maintain the electrical compatibility.

In some embodiments, the plugs of the male connector 315 may be positioned within a slot module. In this embodiment, the module may employ slots P1 and P3, and slots P1 and P4 may be empty or used for various other connector purposes such as discussed above. While the slots P1-P4 are shown in this configuration, alternative configurations for these slots P1-P4 may be employed. For example, a 2-plug male insert of the male connector 215 may be housed in slots P2, P3 or P4. Similarly, a 5-plug insert may be housed in either P1, P2, P3 or P4. One of the unique aspects of the adapter 300 is the wiring scheme where at least one of a selected jack of the 6 jacks 325-350 comprising the female connector 210 may be wired to one of a selected plug of the plugs 365-390 of the male connector 315.

Referring now to FIGS. 4A-4C, there is shown another embodiment of an adapter 400 which may include a first male connector 410 on one end and a second male connector 415 on an opposing end, which may be connected by cables 420. The adapter 400 may be used when an electrical connection at one end of a first piece of equipment, such as a product handling module in a product transfer system, is not compatible with an electrical connection of an adjacent piece of equipment. Referring now to FIG. 4B, there is shown an end view of the first male connector 420 and the second male connector 430. In this example, the first male connector 420 is made by a first manufacturer, such as, e.g., Phoenix, and the second male connector 430 is also made by the same manufacturer. This adapter 400 may be required where a gender conversion is required from an electrical connection of one piece of equipment to an adjacent piece of equipment.

Referring now to FIG. 4C, there is shown an example of a schematic which may represent certain embodiments of a gender conversion adapter such as adapter 400. In this embodiment, each connector 410 and 415 may include a 4-slot module carrier frame. The four slots are numbered as J1, J2, J3 and J4. Slot J1 may house a dual male pin insert, which may in some embodiments be a dual contact insert module, male 2 positions, 40A, 1000V, Axial screw, labeled as J1-1 and J1-2. In some embodiments, these pins may carry the AC power. Slot J2, in this embodiment, may house a solitary RJ45 contact insert module, which in some embodiments, may provide Ethernet capability. Slots J3 and J4 may, in this embodiment, both house a male 5 position plug, such as, e.g. a PT Spring contact insert module having 5 positions. The plugs in slots J3 and J4 may be wired, in some embodiments, to provide the control signals. Plug P5, in this embodiment, may be a ground connection.

The second connector 415 may also be a male connector, and may in some embodiments, have slots labeled as P1, P2, P3 and P4. In some embodiments, the slots P1-P4, and plug P5 may have the same, or similar electrical configuration construction as connector 410.

In some embodiments, the arrangement of plugs within the slots and ports may be altered or adjusted in order to meet an application for connecting a female connection with one of the male connectors 410 or 415. For example, slots J1 and P1 may in some embodiments include AC power plugs and in some embodiments, 10AWG wires may be used connect plug in J1-1 to P1-1 and J1-2 to P1-2. In some embodiments, the cables may include heavy gage wires. Slots J2 and P2 may, in some embodiments, include Ethernet plugs, such as, e.g. RJ45 Ethernet ports. The two Ethernet ports J2 and P2 may in some embodiments be connected by an Ethernet cable, such as a CAT 5E Ethernet cable. In this example, the cable may be specifically selected to facilitate IP based data transfer that allows different equipment within a data transfer system to communicate with each other.

Slots J3, J4, P3 and P4, in some embodiments, may each include 5-plug modules. The plugs, in some embodiments, may be connected by 18AWG wires. In some embodiments, the wires connecting the plugs in slots J3, J4, P3 and P4 may be configured to carry a control signals that allow a logic programs to operate and communicate between the various modules and segments in a product transfer system, such as product transfer system 100.

The two male connectors 410 and 415 may be joined, in some embodiments, by a cable conduit 420 configured to relay or carry the above-mentioned wiring. The length of the conduit may be varied according to the given application In some embodiments, such as the example shown, the length may be 20 inches, but there may be other embodiments with shorter or longer lengths such as, e,g., about 2 inches to about 48 inches, or even longer or shorter as needed.

Accordingly, the adapter 400 may facilitate more flexibility in arrangement of certain equipment on a manufacturing, warehouse, or product transfer area. Additional examples and details will be shown and described herein.

FIGS. 5-7 illustrate examples of product moving systems which may include embodiments of product moving and industrial equipment. The product moving and industrial equipment may employ embodiments of an electrical adapter including adapters 200, 300, or 400. The electrical adapter according to the disclosure may facilitate greater flexibility in design and implementation of product transfer systems and enable a layout or flow change even after a product transfer system has been installed. For example, certain conveyor segments may be programmed to move product in different directions and may be programmed to change direction even after the conveyor segment has been installed and implemented into a product transfer system. Various product transfer equipment and segments may include various electrical connections, including, but not limited to 9-jack female connectors (such as manufactured by Phoenix or Epic), 9-plug male connectors, 6-jack female connectors, 6-plug male connectors, and various other multi-jack and multi-plug electrical connections.

FIG. 5 illustrates one embodiment of a product moving system 500 which may include the following equipment connected: a flexible conveyor 510, a curve connector 515, an extension conveyor 520, a gapping conveyor 525, and a scanner 530. Other equipment may be connected at either end of the system 500, the equipment shown in for illustrative purposes and the system is not limited to these components. As shown in this example, each piece of equipment may employ different types of connectors at each at end thereof and various embodiments of the adapters, 200, 300, and at least 400, may be used to electrically couple adjacent equipment within the system 500 when the male/female connection is not compatible or one connection may include 6 jacks/plugs and the adjacent connection has 9 jacks/plugs. For example, the flexible conveyor 510 may include a female connection 512 at its upstream end and a male connection 514 at its downstream end. Flexible conveyor 510 in this embodiment is connected with a curved conveyor segment 520 that has a female connection 522 at its upstream end. However, at the downstream of the curved conveyor segment 520 (carrying Phoenix female connector), an electrical connection to extension conveyor 530 may not be made without an adapter according to the disclosure because, in this example, the upstream connector of the extension conveyor 530 has a Phoenix female connector. As such, the two female connectors 524 and 526 may not be compatible and as such, may require an adapter such as adapter 400 to connect them. In this embodiment, the extension conveyor 530 may be compatible with the gapper conveyor 540 since the extension conveyor 530 includes a Phoenix male connector at its downstream end which is compatible with the Phoenix female connector on the upstream end of the gapper conveyor 540. The gapper conveyor 540 may also be compatible with the scanner 550 since the Phoenix male connector at its downstream end is compatible with the Phoenix female connector at upstream end of the scanner 550.

FIG. 6 illustrates another example of a product mover system 600 which may employ equipment from various manufacturers. In this example, the system includes at least an expandable conveyor 610 from a first manufacturer, and at least a 90° curved conveyor segment 615 by a second manufacturer, an extension conveyor 620, a gapping conveyor 625, and a scanner 630 connected in series. The expandable conveyor 610 may include a female connector 612 made by a first manufacturer at its upstream end and a male connector 614 made by a second manufacturer at its downstream side. In some embodiments, the expandable conveyor 910 may be incompatible with certain equipment from the second manufacturer. Examples of connectors not compatible are illustrated in FIG. 6. Accordingly, one or more adapters according to the disclosure may be needed to connect at least two of the pieces of equipment in system 600. For example, the adapter 200 may be used between at least the expandable conveyor 610 and the 90° curved conveyor segment 615 to overcome the incompatibility between the two adjacent equipment and connectors a male connector 614 and a female connector 616. While these are a male to female connection, the jacks and plugs may not be compatible and as such, adapter 200 is required to complete the connection. In addition, the conveyor segment 615 has a female connection 618 at its downstream end which is incompatible with a female connection 622 of the extension conveyor 620 at its upstream end. As such, a gender conversion adapter, such as adapter 400 may be required to complete the electrical connection.

Referring now to FIG. 7, there is shown another configuration of the product transfer system 700 that may include at least an expandable conveyor 710, an extension conveyor 715, a gapper conveyor 720, and a scanner 725 which may be connected in series. As shown, since the expandable conveyor 710 may include an EPIC male connector 714 at its downstream end, and as such, may not be electrically incompatible with the extension conveyor 715, which in this example includes a Phoenix female connector 716 at its upstream end. This incompatibility may be overcome by using an embodiment of an adapter according to the disclosure, such as, e.g., adapter 300. The drawing includes various symbols such as EF, EM, PF, and PM, are provided only as examples and embodiments according to the disclosure are not to be limited by such abbreviations and characterizations.

Various embodiments of a product transfer system, components therein, and electrical adapters have been disclosed herein. In some aspects, there may be a product transfer system comprising a plurality of conveyors, wherein the conveyors may include one or more flexible conveyors, one or more expandable conveyors, one or more gapper conveyors, or one or more 90° curved conveyor segments; wherein the plurality of conveyors may be connected in series and may also be coupled with a scanning module. In some embodiments, at least two of the conveyors placed in series may not be electrically compatible with the adjacent conveyor in the series. As such, the system may further include at least one electrical adapter, wherein the electrical adapter is one of a first adapter or a second adapter. The first adapter may include a female connector at one end and a male connector at an opposing end. The second adapter may include a male adapter at one end and another make adapter at an opposing end. In one embodiment, the first adapter may include an EPIC 9-pin female connector at one end and a Phoenix 6 pin male connector at the opposing end. In another embodiment, the second adapter may include a male Phoenix 9-pin connector at both ends. In other embodiments, the second adapter may include a female connector at both ends.

In some aspects, an electrical adapter includes an EPIC female connector and Phoenix male connector. The two connectors may be held together by a pigtail conduit of re-determined wiring. The adapter may allow electrical compatibility between equipment from various manufacturers to be connected in series with each other. While connectors and electrical connections have been discussed in some embodiments using certain manufacturers as examples, including Epic and Phoenix, embodiments of the adapters according to the disclosure are not limited to these manufacturers and may include connectors and connections may be made by any manufacturer of male and female connectors and electrical connections.

In another aspect, a gender conversion adapter may include a male connector at each ends thereof. The two male connectors may be held together by a pigtail conduit of pre-determined wiring as explained above. This gender conversion adapter may be applied, in some embodiments, where a curved conveyor segment may be installed into a product transfer system.

In other aspects, there may be a curved conveyor segment which may toggle between two flow directions, such that in a first setting, product may flow from right to left. In a second setting, product may flow from left to right. In one embodiment, at least one adapter according to the disclosure may connect the curve connector with at least one adjacent piece of equipment in the product transfer system.

The adapters according to the disclosure allow for improved modularity in a product transfer system irrespective of the manufacturers of each piece of equipment incorporated into the system.

Aspects disclosed herein include:

Aspect A: An electrical adapter, the adapter comprising: a female connector at one end; and a male connector at an opposing end, the male connector coupled with the female connector via wiring; wherein the female connector is a six jack connector wherein at least a first of the six jacks is configured for AC power, and at least a second of the six jacks is configured for relaying control signals; and wherein the male connector is a nine plug connector having at least a first of the nine plugs is configured for AC power, and at least a second and third plug of the nine plugs are configured for relaying control signals.

Aspect B: an electrical adapter, the adapter comprising: a first male connector at one end and a second male connector at an opposing end, the male connectors coupled via wiring; wherein each male connector is a nine plug connector having at least one plug configured for AC power, and two or more plugs configured for relaying control signals.

Aspect C: a product transfer system, the system comprising: a curved conveyor segment, the curved conveyor segment configured to switch between at least a first product flow direction and a second product flow direction, and having at least a first electrical connection at one end thereof; a product handling segment adjacent to the curved conveyor segment, the product handling segment having an electrical connector at one end thereof; and at least one electrical adapter for connecting the curved conveyor segment with product handling segment, wherein the at least the first electrical connection of the curved conveyor segment is incompatible for connection with the electrical connector of the product handling segment; wherein the at least one electrical adapter includes a first electrical adapter connector at one end thereof and a second adapter connector at an opposing end.

Aspects A, B, and C may have one or more of the following additional elements in combination: Element 1: wherein at least another of the six jacks is an Interlock IN connection; Element 2: wherein at least another of the six jacks is an Interlock OUT connection; Element 3: wherein at least another of the six jacks is configured for an Ethernet port; Element 4: wherein at least another of the nine plugs is an Interlock IN connection; Element 5: wherein at least another of the nine plugs is an Interlock OUT connection; Element 6: wherein the nine plugs are positioned in four-slot module carrier frame; Element 7: wherein five of the nine plugs are positioned in a same slot of the four-slot module carrier frame; Element 8: wherein the female connector includes 9 jacks; Element 9: wherein the male connector includes only 6 plugs; Element 10: wherein the first electrical adapter connector is a six jack female connector, wherein at least a first of the six jacks is configured for AC power, at least a second of the six jacks is configured for relaying control signals; Element 11: wherein the first electrical adapter connector is a nine jack female connector, wherein at least a first of the jacks is configured for AC power, at least a second of the jacks is configured for relaying control signals; Element 12: wherein at least another of the jacks is configured for an Ethernet port; Element 13: wherein the first electrical adapter connector is a nine plug connector having at least one plug configured for AC power, and two or more plugs configured for relaying control signals; Element 14: wherein the second electrical adapter connector is a nine plug connector having at least one plug configured for AC power, and two or more plugs configured for relaying control signals; Element 15: wherein the plugs are positioned in four-slot module carrier frame; and Element 16: wherein five of the plugs are positioned in a same slot of the four-slot module carrier frame.

Further additions, deletions, substitutions and modifications may be made to the described embodiments

What is claimed is:

1. An electrical adapter, the adapter comprising:
a female connector at one end; and
a male connector at an opposing end, the male connector coupled with the female connector via wiring;
wherein the female connector is a six jack connector wherein at least a first of the six jacks is configured for AC power, and at least a second of the six jacks is configured for relaying control signals; and
wherein the male connector is a nine plug connector having at least a first of the nine plugs is configured for AC power, and at least a second and third plug of the nine plugs are configured for relaying control signals.

2. The electrical adapter according to claim 1, wherein at least another of the six jacks is configured for an Ethernet port.

3. The electrical adapter according to claim 1, wherein at least another of the six jacks is an Interlock IN connection.

4. The electrical adapter according to claim 3, wherein at least another one of the six jacks in an Interlock OUT connection.

5. The electrical adapter according to claim 1, wherein at least another of the nine plugs is an Interlock IN connection.

6. The electrical adapter according to claim 5, wherein at least another of the nine plugs is an Interlock OUT connection.

7. The electrical adapter according to claim 1, wherein the nine plugs are positioned in four-slot module carrier frame.

8. The electrical adapter according to claim 7, wherein five of the nine plugs are positioned in a same slot of the four-slot module carrier frame.

9. An electrical adapter, the adapter comprising:
a first male connector at one end and a second male connector at an opposing end, the male connectors coupled via wiring;
wherein each male connector is a nine plug connector having at least one plug configured for AC power, and two or more plugs configured for relaying control signals.

10. The electrical adapter according to claim 9, wherein at least another of the nine plugs is an Interlock IN connection.

11. The electrical adapter according to claim 11, wherein at least another of the nine plugs is an Interlock OUT connection.

12. The electrical adapter according to claim 9, wherein the nine plugs are positioned in four-slot module carrier frame.

13. The electrical adapter according to claim 12, wherein five of the nine plugs are positioned in a same slot of the four-slot module carrier frame.

14. A product transfer system, the system comprising:
a curved conveyor segment, the curved conveyor segment configured to switch between at least a first product flow direction and a second product flow direction, and having at least a first electrical connection at one end thereof;
a product handling segment adjacent to the curved conveyor segment, the product handling segment having an electrical connector at one end thereof; and
at least one electrical adapter for connecting the curved conveyor segment with product handling segment, wherein the at least the first electrical connection of the curved conveyor segment is incompatible for connection with the electrical connector of the product handling segment;
wherein the at least one electrical adapter includes a first electrical adapter connector at one end thereof and a second adapter connector at an opposing end.

15. The system according to claim 14, wherein the first electrical adapter connector is a six jack female connector, wherein at least a first of the six jacks is configured for AC power, at least a second of the six jacks is configured for relaying control signals.

16. The electrical adapter according to claim 15, wherein at least another of the six jacks is configured for an Ethernet port.

17. The system according to claim 14, wherein the first electrical adapter connector is a nine plug connector having at least one plug configured for AC power, and two or more plugs configured for relaying control signals.

18. The system according to claim 14, wherein the second electrical adapter connector is a nine plug connector having at least one plug configured for AC power, and two or more plugs configured for relaying control signals.

19. The electrical adapter according to claim 18, wherein the nine plugs are positioned in four-slot module carrier frame.

20. The electrical adapter according to claim 19, wherein five of the nine plugs are positioned in a same slot of the four-slot module carrier frame.
